(19) United States
(12) Patent Application Publication
(10) Pub. No.: US 2002/0010941 A1
(43) Pub. Date: Jan. 24, 2002

(54) Method/apparatus for improving WEB (internet) access

(76) Inventor: Kevin M. Johnson, Natick, MA (US)

Correspondence Address: Steven J. Grossman, HAYES, SOLOWAY, HENNESSEY,, GROSSMAN & HAGE, P.C., 175 CANAL STREET, MANCHESTER, NH, 03101-2335, US

(21) Appl. No.: 09/756,327

(22) Filed: Jan. 8, 2001

Related U.S. Application Data
(60) Provisional application No. 60/174,677, filed on Jan. 6, 2000.
(60) Provisional application No. 60/181,260, filed on Feb. 9, 2000.

(51) Int. Cl. H04N 7/173

(52) U.S. Cl. 725/108

(57) ABSTRACT

The invention herein uniquely connects the real world of consumers to the world of the web or the domain of universally accessible information and commerce. Through a process of “tagging” or “placemarking” experiences via connectivity devices containing associated programming, consumers will now find access to desired information readily accessible, and readily communicated. In various embodiments, and as a consequence of the invention herein, television, radio and all printed material will now provide a method for consumer tagging without altering the basic technology or format behind such informational media. A device is carried by the consumer and provides a unique means for tagging information. Comparing the tagged information with a central web database provides the consumer a brief description and a direct link to the information desired. The technology herein can either be embodied in a separate device or integrated in a more capable multi-functional product.

### CROSS REFERENCE TO RELATED APPLICATIONS

This application claims the benefit of U.S. Provisional Application Serial No. 60/174,677, filed Jan. 6, 2000, and U.S. Provisional Application Serial No. 60/181,260, filed Feb. 9, 2000.

### FIELD OF THE INVENTION

The present invention relates to capturing events (time, audio, and/or venue) or location (gps position, still video) into a device memory as a selected placemark, which placemark then operates to extract links to additional information via the world-wide web.

### BACKGROUND

The internet has recently gained tremendous popularity. Consumers are unable to turn on the radio or read the paper without learning about some new internet phenomenon or the rapid rise of e-commerce. However, the internet is still a place separate from the world that we actually live in. Most of the experiences consumers have during the day are largely devoid of internet content, and when individuals want to “get on” the internet, they are forced to chain themselves to a seat in front of a monitor in order to “enter” the vast world of network information.

Stated another way, internet providers are focusing more and more on continuous, wireless and universal access to the internet. Internet based businesses are trying to improve their web based products and services to motivate the on-line consumer to eventually spend money, either directly or indirectly, through their URL. However, the 2 dimensional flat screen world of the internet remains largely divorced from the 3 dimensional world of experiences and interactions that consumers travel during 99% of a working day. Consequently, most consumer time is spent navigating the labyrinth of the internet instead of obtaining the specific information consumers desire.

How well consumers can make use of the internet is now primarily based on how well one can find their way through the labyrinth of URL's, and screen after screen of links and subsets. Web browsers therefore all have a sense that what they are looking for is out there, but few really know how to get there efficiently, if at all. What's more, almost all the things about which browsers may be most interested are presented in a format that is not internet based. It's an article, a product, a television show, a book, a radio program or something else that becomes part of one's everyday experience, which prompts individuals to want to learn more about a topic or issue.

Every time consumers look at something or hear about something in the “real world” there is likely to be a vast amount of interesting and applicable information about it somewhere in the “web” world. Whoever or whatever was involved in creating the things that are seen, the items that one holds, or the words read or transmitted, has much more to tell us, but can't practically reach us because of space, time or financial constraints. In addition, since the information supplier is unaware whether any particular individual wants more than top level information, there is always a tradeoff about how much information to initially provide.

Ideally, when individuals have an experience with something during the day, they should be able to get information about it without having to guess where it is or how to get it. Starting to look for information at the beginning, or even middle of the “web” labyrinth, is often frustrating and unnecessary. Therefore, creating a means for linking the real world to the world of electronic information is essential to improving the consumers' incessant desire to maximize their day-to-day learning experience.

With regards to the foregoing, a number of disclosures have recently come forward aimed at internet access. For example, U.S. Pat. No. 5,832,223, entitled “System, Method and Device for Automatic Capture of Internet Access Information In A Broadcast Signal for Use by an Internet Access Device” relates to automatic capture of internet access information in a broadcast signal for use by an internet access unit. The system described therein first comprises a broadcast unit having an internet access information unit, coupled to receive internet access information, for encoding the internet access information into a broadcast signal to provide an augmented signal and broadcasting said augmented signal. The system also is said to include a receiving unit for receiving the augmented signal for a user, a capture unit coupled to the receiving unit and interfaced with the internet, for automatically storing/utilizing the internet access information in accordance with a predetermined scheme at a predetermined time upon intitiation of the predetermined scheme. In addition, a display/television screen/audio unit is coupled to the access unit and, where selected, to the receiving unit, for displaying either the video/audio/textural information obtained by using the internet access information, or video, audio, textural information from the broadcast signal.

Attention is also directed to U.S. Pat. No. 5,961,603, entitled “Access System and Method for Providing Interactive Access to an Information Source Through a Networked Distribution System”. This disclosure relates to a system and method for accessing internet based information through a user television in a television distribution network. It is said to enable a user to access and view information which is related to the programming content of a currently viewed television broadcast. The concept is defined as “channel hyperlinking”, and is said to enable a television viewer to dowload internet web pages and the like, which are related to a currently viewed advertisement, program, newscast, etc.

Accordingly, it is a general object of the invention to provide both an improved product and process to allow consumers a more efficient and improved pathway/link to additional information via the world-wide web.

Along such lines, it is a more specific object of this invention to provide consumers with an improved product and process to placemark daily events into a device memory, and later rely upon such placemarking to automatically and conveniently provide the consumer corresponding links on the world-wide web.

In addition, it is also an object of this invention to recognize that the aforementioned events, as well as physical location itself, can and will prompt a consumer to seek additional information. Accordingly, the invention herein thereby uniquely identifies that such factors (events and/or location, etc.,) can now be comprehensively identified and automatically associated with a corresponding web link for convenient delivery of supporting information relating to such event and/or location.

Finally, it is an object of this invention to provide a product and process for web searching and information gathering that is more closely tied to the way that consumers collect and sort information, via a consumer's senses (touch, vision, hearing) in relation to time.

### SUMMARY OF THE INVENTION

A product and process is disclosed, which captures an event (time, audio and/or venue) or location (gps position, still video) into memory as a selected placemark, which placemark then readily and conveniently extracts links to additional information via the world-wide web. The product/process is uniquely applicable to the placemarking of events associated with such consumer media as television and/or radio, and further includes the placemarking of written information supplied via printed media. In addition, a process will be described where consumers can also extract information from the internet based on their physical location, e.g., in front of a building, in the middle of a town, by a billboard, etc.

In alternative embodiment, a system is disclosed for capturing internet access information related to the following variables, or at least two of the variables in combination: (1) video aspects; (2) audio aspects; (3) geographical position or movement; and (4) time, comprising:

(a) a capture unit comprising:

(i) a database for receiving and storing at least two or more of said variables;

(ii) a selector which upon actuation thereof stores at least two or more of said variables;

(b) an interface for coupling said capture unit to said internet to access internet information wherein said interface extracts links from an internet web site which supplies said information related to two or more of said variables stored in said capture unit database.

### BRIEF DESCRIPTION OF THE DRAWINGS

For a better understanding of the present invention, together with other objects, features and advantages, reference should be made to the following description which should be read in conjunction with the following figures wherein like numerals represent like parts:

FIG. 1 is a schematic illustration of an exemplary computer system useful in connection with embodiments of the one or more invention;

FIG. 1A is a schematic illustration of an exemplary television-based system consistent with the invention;

FIG. 2 is a schematic illustration of an exemplary radio-based system consistent with the invention;

FIG. 3 is a schematic illustration of an exemplary printed matter based system consistent with the invention;

FIG. 4 is a block diagram showing an exemplary process flow consistent with the invention; and

FIG. 5 is a block diagram showing another exemplary process flow consistent with the invention.

FIG. 6 is a more detailed block diagram, further illustrating the process flow of the present invention.

### DETAILED DESCRIPTION OF PREFERRED EMBODIMENTS

The invention described here is a combination of products and systems (methods) that allow a consumer to more effectively link their world to the world of information—the web. Any time a consumer wants more information about anything, something in the real world “triggered” that desire. This disclosure will focus on how consumers can identify and store these triggers, which can then be turned into opportunities for more information through the internet.

There are two primary areas around which this web information system is defined, time (event) based triggers and space based triggers (a physical item or location). For the time based arena, the two areas which are most commonly known to consumers are television or radio. Of course there are also other event-related triggers (like a conversation with another person), which will also be discussed herein. The space based web information system makes a distinction between two basic information triggers, those that are largely stationary and those that are mobile. Stationary items would include buildings, real estate, towns, counties, states, billboards . . . etc. Mobile items would include, but are not limited to physical products, printed material (magazines, newspapers, books, coupons . . . etc), and even items such as vehicles. A consumer's experience with any of these often triggers a desire for more information, and the present invention uniquely provides a more efficient and novel technique for the consumer to access this information.

### 1. Time Based Trigger—Television

According to the present invention, while a viewer is watching television, each new screen image, advertisement or topic can provide a link for the viewer regarding where and how to find more information. Anytime an individual now views something interesting, they can be conveniently delivered to a specific internet address that provides a location to find more information—i.e., preferably not a home page, which is just the middle of the labyrinth.

That is, in the context of the present invention, the specific internet address delivered to the consumer will satisfy the consumer's curiosity for additional information, provided by their viewing experience, and does not simply offer another generic form of the information digested by the consumer, which information prompted the inquiry.

Furthermore, most individuals do not want to interrupt a program (or television viewing time, in general) to obtain more information about an advertisement or topic. Ideally, individuals like to investigate the topic upon completion of the program. In accordance with the present invention, such option is now realized.

Of course, it is always possible for a network to provide a URL anytime something is shown or discussed on TV. However, practically speaking, this is visually annoying and typically impractical, since the URL's would be painfully long to contain any degree of specificity. In addition, individuals are usually unable to write them down in real time, thereby making such option largely unrealistic. Furthermore, when URL's are shown on TV (usually for ads), they are ordinarily for a general home page, and not a particular topic or piece of information.

In such context, the present invention provides a method for automatically tracking and storing what topics people find interesting and allowing them to access information about them at their convenience. Of course, with the advent of webTV™, there is currently a vehicle for accessing the internet while watching television. However, it will be a long time before the majority of Americans are connected to interactive webTV, and furthermore, in webTV, there is no opportunity for allowing users to unobtrusively track interesting topics for subsequent viewing.

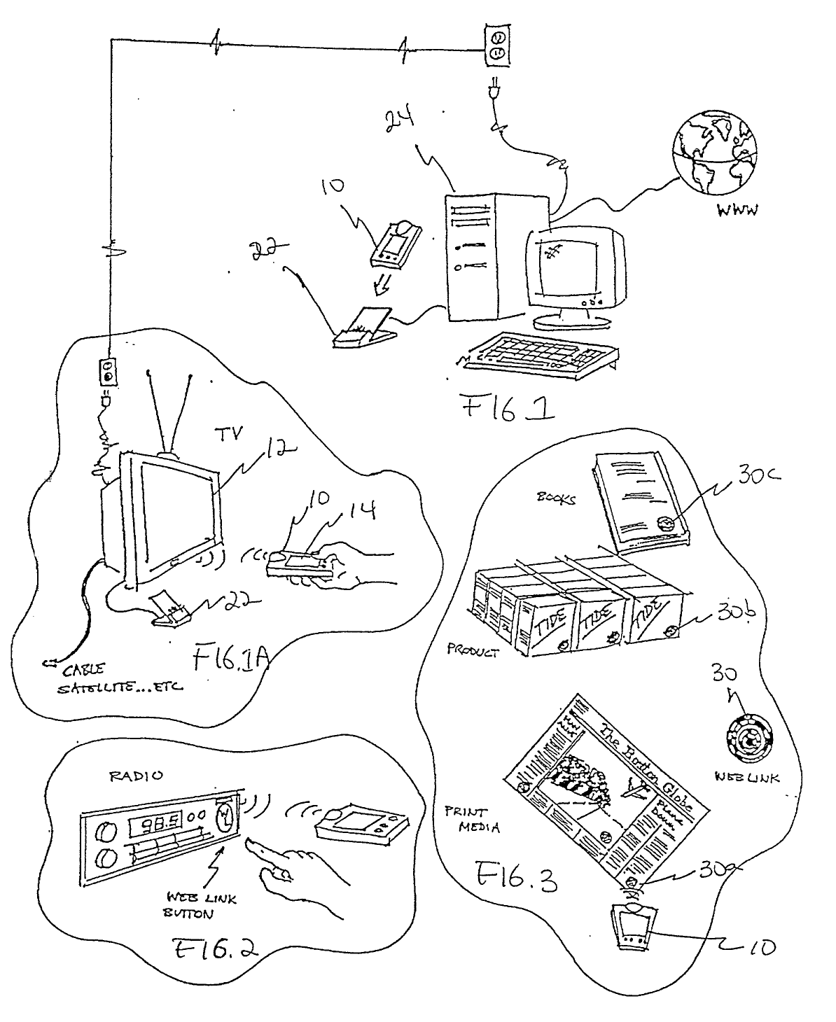

Accordingly, in an exemplary embodiment of the invention as shown in FIGS. 1 and 1A, a user is provided with a remote control 10 for their television 12. A button 14 on this remote can be depressed anytime a user finds something of interest, e.g. in a television program during an advertisement, or in the middle of a show. The network (and/or advertiser) can then provide as much information about a TV moment as deemed appropriate.

For example, if someone were watching a sitcom and saw a product in a scene about which they wanted more information, they could depress the button 14. By depressing button 14 at such moment, the viewer may capture links to: the sitcom's home page, the network's home page, an information/order subpage from the manufacturer of the product, a place to buy a CD for the background music . . . etc. Alternatively, someone pushes the button 14 during an ad, they could obtain an information/order subpage from the manufacturer of the product (or supplier). Expanding on this concept, if someone depresses button 14 during a nature show, in the middle of a segment about, e.g., gorillas, they may obtain links to specific gorilla studies, information about the videographers and photographers involved in creating the show, maps about concentrations of the gorilla population, information about the countries in which gorilla's primarily reside . . . etc. Accordingly, regardless of which viewing experience provokes the viewer to press button 14, it will always be up to the television programmer to decide what is relevant and what should ultimately be made available to the consumer to satisfy their quest for additional information

One exemplary technique of capturing information consistent with the invention, considers the combination of time (of the day) and the channel (network) that the viewer is watching. In such scenario there is no need for any alteration of existing televisions or signals to capture the information. The remote 10 has a real time clock (so it “knows” the time) and also knows which channel is “on”, as it was the device that tuned the TV to a particular station. (In addition, the device can also store it's location (Boston, Philadelphia . . . etc) if it has either a gps or a means for programming or storing this information.)

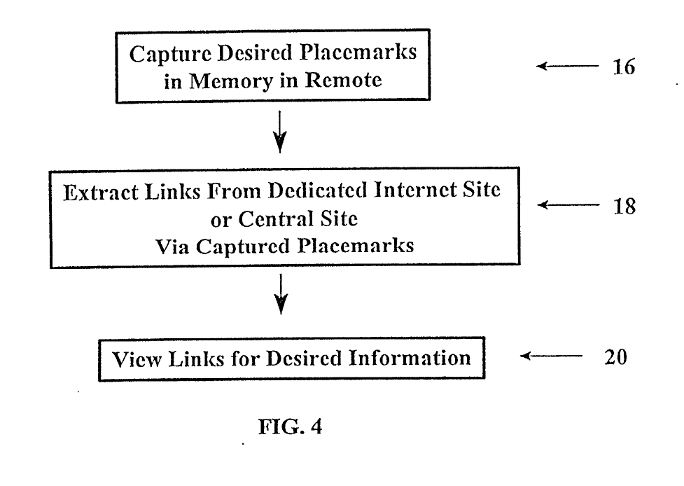

With reference also to FIG. 4, which is an exemplary block diagram of the process of the present invention, when the viewer depresses the button 14, they are simply putting a placemark in time for the channel they are viewing. Accordingly, as shown at 16, there is capture of the desired placemark in memory on the remote, followed 18, extraction of links from a dedicated site or central site, and 20, viewing of the links for desired information. In that regard, and as more fully discussed herein, the presently disclosed device may also serve as an interactive device, in the sense that the device collects information about viewing habits of an individual. The device can therefore, when extracting links, elect to download such information to a ratings service that collects and distributes information about consumer television viewing trends.

When the user then logs onto the web, they are therefore taken directly to a website (the “placemark” web site) specifically created for the purpose of interpreting information downloaded from the web information device. In a preferred embodiment, the device would have stored information which would direct their web interface device 22 (computer, PDA . . . etc) to the “placemark” web site directly. In one embodiment, the device would not only direct the user to the “placemark” site, but would also be responsible for logging, the user on to the internet. Once the remote (or other web info device) was “docked” and the “placemark” web site reached, placemarks would be downloaded from the remote (or other web info device) to the site. The centralized web site would then extract the links associated with a given network at a specific point in time from a database provided by the venue provider. The site would then subsequently display pertinent web links for each trigger (event) to the user. In one preferred embodiment, the information would be displayed to users in a way that would show a chronology of all triggers which created their corresponding placemarks, including such items as venue (TV station), program, time, audio clip, still video, brief summaries and/or web links. The user could then click on a title or icon and be brought to the specific location of the information for viewing 20. They may also need to specify in what area and/or time zone they were watching to get the accurate info (if this is not pre-specified by the device or software). If necessary, it is possible to have a synchronization signal issued at the beginning of a show for the remote to make certain that the absolute time is generally correlated to a clock in the remote. Of course, if the remote is more sophisticated, like a PDA (Palm), it could access the internet directly at anytime and find pertinent information without a dedicated PC.

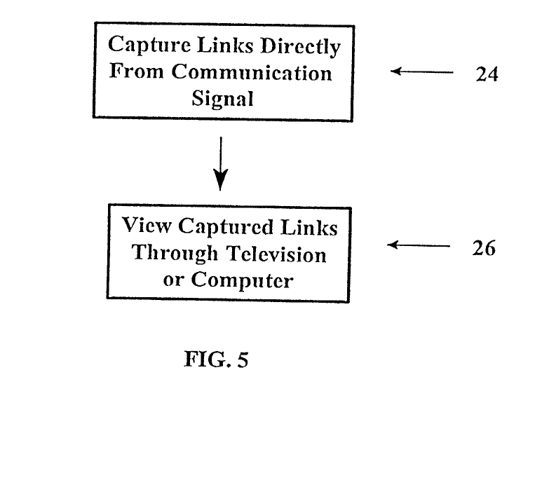

With reference to FIG. 5, another exemplary method of capturing information involves communicating the link information via a signal which is carried on top of the normal picture and audio television signal. Alternatively, the signal may carried within the normal picture and/or audio television signal. This signal can be stored by the TV 12 or remote 10 (communicated by either a docking with the TV or through wireless R.F.) when the user depresses the button 14. These links can then be explored through docking the remote 10 with a PC interface 22 (as before) or directly through the television (webTV or sophisticated remote). It is also possible to download this information directly to a box connected to a PC through either an R.F. or a signal carried on top of AC power.

Pursuant to the present invention, the network and its advertisers have good reason to provide the invention herein as it offers:

Better, more integrated service to customers.

More opportunities for generating revenue through advertised or ancillary items.

Information about who is viewing the shows and accessing the extra information.

### 2. Time Based Trigger—Radio

In a further embodiment of the present invention, providing information about topics someone hears on the radio can have much (or more) value than it does for television. Unlike television, where someone could theoretically run to their computer (or execute a webTV link), most radio listeners are in a remote location—a car, the beach, the yard . . . etc. The confusion over the spelling of a name alone is enough to warrant implementation of the present invention. Indeed, in spite of diligent efforts by announcers to somehow communicate the spelling of a word or name, people ordinarily have difficulty remembering. Listeners typically scramble for a pencil to try and capture the information before they forget it. According to the present invention, there is now an opportunity to obtain more information about any topic related to what a listener is now hearing . . . music, talk radio, sports, news, . . . etc.

With reference to FIG. 2, the system herein operates in a manner similar to the TV system, with a remote control tracking the station and time when a user depresses the indicated button. However, in most cases, there is no remote for a radio. Where there is no remote, either for a radio or television system, a separate button can be provided directly on the radio or television to capture the time and tuned station when the button is depressed. They would be downloaded by either wire, R.F. or I.R. to a transport device—very much like a remote (or PDA). This remote is then placed into a docking station and information is made available as described above with respect to television.

Alternatively, with respect to the radio, the AM and FM signals could also have linking information carried on their primary audio signals, or within said signals. When a user depresses the indicated button (FIG. 2), the addresses of relevant information would be stored in the radio and then subsequently downloaded to a transport device by IR, RF or a physical connection.

Various modifications and alternative embodiments are possible. For example, if a remote can “read” the station a radio is currently tuned to, then the system can operate exactly like the television remote with no alterations to existing signals. This can be done through I.R., R.F., wire or with the aid of a visual scanner, which will actually recognize the display on a radio. As mentioned before, if the remote is sophisticated enough (like a PDA), it can access the information directly through the web.

In addition to the above, those skilled in the art will recognize that, e.g., in the case of an audio broadcast, such may comprise audio produced from a device that plays prerecorded audio, such as a compact disc (CD) or tape player. In like manner, a video broadcast herein may simply comprise a video signal produced from playback of a video cassette recorder (VCR) or digital video disc (DVD). Furthermore, in the broad scope of the present invention, audio herein may also comprise speech, in which case the system herein for capturing internet information would recognize such speech as providing an internet address and access such internet address when coupling to the internet.

### 3. Mobile Space Based Triggers—Printed Material/Physical Items

Another group of items that stimulate consumers to desire more information is printed material (newspapers, magazines, advertisements, flyers, labels, business cards . . . etc.) This group also includes 3 dimensional physical items because the information is relayed through the use of contact printing or labels. The purpose of using the invention herein for such objects is the same as it is for television or radio—connecting people directly with pertinent information.

With respect to FIG. 3, this system involves the use of an encrypted icon 30 or indicia that is placed in proximity to the printed material and can be scanned by the remote 10. The icon is simply printed next to any item for which there may be a reason to connect users to more information about a topic—a newspaper article, an ad, a label on a product, advertisement on the side of a truck . . . etc. In its simplest form, this could be a bar code. If more information is desired, it could be a 2-D indicia (post office new type) or a custom pattern. The icon may provide several different types of information. For example, it may provide a unique serial number, which is a triggered to download all appropriate links when someone connects to the site, or it may provide the URL's directly without needing to go through the site. In either case, a user would simply point the PDA at the indicia and collect the information. A consumer can, therefore, walk up to just about anything, scan an icon and have an easy method to secure additional information. For a product, it could be use or maintenance instructions, major distributors, current or related models, places to buy on-line, service locations, features, recent favorable reviews . . . etc. And, of course, all of this enables customers to purchase items and provide information to URL owners about who is hitting their site and where they obtained the information (as described before, all encrypted in the indicia). And, like the time-based scenarios, the providers will have the ability to continuously “adjust” the links/information associated with a given indicia as time passes. For instance, the indicia on a book which was recently reviewed by the New York Times, can now direct a user to the recent review without changing the indicia—just the software database.

Because the cost of digital imaging will continue to decrease and the resolution will continue to increase, the system will eventually not use dedicated device scanners, but built in digital cameras with software capable of recognizing and “pulling out” indicias from digital images for processing. As described later, since imaging will be part of the user's chronology, this will enable someone to capture more than a numerical association with an abstract barcode. The user will also have a version of the image they actually saw when an item “triggered” their interest.

Quite apart from the foregoing, in yet a further embodiment of the present invention, in those situations wherein the product/process herein is applied, e.g., to a three-dimensional object, or any object of interest to the user, the requirement of an encrypted icon or similar indicia on the object can be rendered completely unnecessary, in favor of the use of the general visual (or audio) aspects/features of the object at issue. In that regard, the use of general visual (or even audio) aspects, as used herein, is reference to the fact that any object will itself, on its own, serve as sufficient visual (or audio) indicia for the device herein to placemark in memory, which placemarked imaged (or audio) can then be matched with a stored database of general visual (or audio) aspects, when linked to the world-wide web, followed by delivery of the user to the appropriate URL for the object in question.

For example, as applied to a given consumer product, it is typical for such products to contain within its general visual image an indicia such as an insignia, logo, trademark, or other visible feature, which can be captured as part of the general visual image, and properly matched with a database of such indicia when connecting to the web. Alternatively, the use of an insignia, logo or trademark can be replaced completely, in the sense that a consumer object itself will, as noted, have sufficient and distinct general imaging (or audio) characteristics, or what one can understand as a general and visual (or audio) fingerprinting characteristic, which can be stored in device memory, and when compared to a database of such general visual (or audio) fingerprinting characteristics, serve to bring the user to the appropriate web site. Furthermore, in the case of audio extraction, the audio may be such audio that the listener does not necessarily hear, providing an “invisible” audio indicia for the device herein. For example, subtones or overtones would be one preferred example.

Expanding further on the use of a general visual (or audio) fingerprinting characteristic, the device herein also contemplates the use of optical character recognition (OCR), in the sense that, e.g., when a written document is place-marked, written information is detected (OCR), and such written information itself can serve as the identifier for directing the user to a desired web site. In terms of such example, the device herein could be used, for instance, to scan a document containing a foreign language of which the user is unfamiliar. By then downloading such foreign language image to the internet, the device herein would then couple the user to, e.g., a translation internet location, or other similar site, so that the user could conveniently translate the information previously presented by the “real world”.

Of course, in those situations wherein the device herein captures an image (or audio) containing more than one visual (or audio) fingerprinting characteristic, and each visual (or audio) fingerprint itself will therefore have its own URL, and the user will, accordingly, be supplied with a list of possible internet sites for which the user can then conveniently select those which he/she would like to visit in order to obtain additional information regarding the object in question.

In that regard, the system herein contemplates that on the internet side of the invention, a complete database of visual (or audio) fingerprints will be created and stored into memory, which memory database will then serve as the appropriate comparative database for which the device herein will identify and select the appropriate match, and provide the user with the appropriate web site link for the purpose, once again, of obtaining additional information regarding the object in question. That being the case, the device herein uniquely delivers the consumer to a URL, by simply capturing a general visual (or audio) fingerprinting characteristic of the object of interest, thereby rendering it unnecessary to use present day features such as bar-coding which must be separately created and installed on a device, for electronic identification thereof.

### 4. Stationary Space Based Triggers—Real Estate, Towns, Buildings . . . etc.

Another group of items which can trigger a consumer's desire for more information can be organized under the “Stationary Space Based” category. Anytime someone is anywhere, they will be able to get “relevant” information for that particular location by hitting a button. This button will store the user's physical location by committing a gps signal to memory. Like the system described for television, radio and mobile items, the web info device containing the gps will be “docked” into a web accessible device (if it does not have embedded web access). The set of coordinates will be downloaded to the “placemark” web site, where they will be compared to a database. The software will then extract from the database the appropriate information which corresponds to the coordinates. The information will then be presented to the user in a form that will enable them to access related links directly. In effect, the business model is based on the sale of “virtual real estate” to advertisers or retailers who provide the relevant links to users through the database. Any particular location may have one or more advertisers based on what is happening at that location. Here are some examples:

Clicking the button on a quiet suburban residential street may take a user to the home page for the town they are in.

Clicking in front of a house for sale on another residential street may take a user to the town's home page, the sub-page for that home's listing under the realtor's site, containing specifications, price, status and contact information.

Clicking at a train station west of Boston may take someone to the MBTA's home page, the sub-page for the western commuter rail schedule, status of delays or important news.

Clicking in the middle of the New York thruway can tell someone about road status (weather conditions, delays . . . etc), places to eat or refuel at the next exit . . . etc. A link could take someone directly to the menu of a little diner or sub shop in the center of a town that is accessed by the next exit. Another could provide information about important historical landmarks or points of interest.

Clicking in the middle of a National Park could take someone to information about nearby trails, how to signal to rangers in case of trouble . . . etc.

Clicking on a busy road could take someone to the sites of roadside stores, or list links to subpages about employment opportunities at nearby locations.

Of course, the possibilities are endless and it is not realistic to list them all in this disclosure. Other enhancements to the system include:

Capturing altitude information to isolate businesses on multi-story dwellings

Capturing the movement of users: direction, speed . . . etc to figure out what information should be provided, e.g. east bound exit information vs. west bound exit information.

Identifying the orientation of the capture device to provide even better specificity about what the user may be “pointing” at. This could be very valuable in busy areas where many things could trigger a user's interest. This could be “line of site” determination or based on triangulation.

Comparing images captured during the button press to stored images in the database in a general vicinity to make a better determination about the users inquiry and provide better information.

Having emitters (and potentially receivers) in the space based triggers (stationary or mobile) which can “lock on” to a user's gps device when they depress their button and download a specific coordinate, or even list of links through RF.

### Integrated System Description

Although each of the scenarios above operate independently of the others, the invention herein also can integrate the functions required for time based and space based material into a single remote device. Because more and more consumers are using items like a Palm™ PDA for all sorts of daily functions, a remote in accordance with the present invention may be readily configured to be “Palm-like” or at least PDA-like in nature. People have already started to justify carrying around electronic assistants for their daily responsibilities and there is no reason to require them to carry around yet another device. In addition, programs have already been created to make PDA devices act like television remotes, and Symbol Technologies has already included scanning capabilities in PDA devices.

An integrated system will be able to provide a historical chronology of all things that either piqued a user's curiosity for more information or were of enough interest or importance to warrant remembering. Many of the chronologued items can be linked to web information through the previously described centralized web site databases, but not necessarily all of them. A meeting with a person, for example, is unlikely to have web information associated with it (unless they provide a business card with a web indicia). In this case, it may be the person's face or some things they were saying which were worth remembering. The ubiquitous questions, “Where did my week go?” and “Where did my day go?” can now be answered to any degree specificity that a user wishes to capture it. When a user docks their capture device, which includes some combination of storing the time, venue, location, audio and image associated with a specific button click, they are downloading an electronic diary of where their time was spent and what caught their interest. In addition, this can be extended to the concept of displaying the chronology of a user's telephone calls with audio capture, or a particular business transaction. Some of these items will have direct web information associated with them and others will not. In addition to providing relevant web information by making the user their “own search engine”, this can also provide value to individuals who need/want to reflect back on their time as a part of their jobs—lawyers, doctors, consultants of any kind . . . etc.

A user will be able to edit their history, deleting unimportant information and adding their own notes about a particular circumstance. In effect, the tool can be used as a reverse “Outlook” or other schedule planning software with much more detailed information—much of it with web based relevant information.

As described before, time based triggers with specific venues, relevant audio or image clips can be supplied by the venue provider and downloaded to the user when they “dock” their capture device. Additionally, images can be provided by/to the user for space based triggers to help them remember, or even sort through, the available information. However, both audio and images can also be stored directly by the user when they press the button on their capture device. This would help simulate the exact experience that triggered an individual's desire to commemorate the event to memory . . . hearing a particular passage in a song or someone making an interesting comment, seeing an image of a product sitting on a store shelf or an image of meeting attendees for an important business gathering . . . etc.

### Means for Audio Capture

An interesting and novel feature provided by this invention relates to capturing audio for items of interest. When a user's interest is stimulated by something they heard (in person or through media), the audio is either completely done or partially done by the time a user can first decide it is interesting, and second, presses a record button. The invention disclosed herein is such that the capture device can be put in a standby mode where a microphone records all audio, all the time, but retains only some portion of it in a buffer before continuously erasing it. For example, a capture device could always store 5 or 10 seconds of audio in a recirculating buffer, erasing the oldest audio and replacing it with new audio. When a user depresses the button, indicating they just heard something of interest, they will be able to freeze the audio buffer and then record going forward. For instance, someone could capture the sounds of a group assembling for a photo right up to the point when they say “cheese”. This basic concept of continuous record can also be extended to still or video imaging.

### Downloading Information to the Capture Device

Although all of the previous scenarios describe a system which captures information for downloading to the internet, the invention disclosed herein also provides for information and data to flow from the internet to the capture device. For all of the scenarios envisioned, the capture device will have a means for storing information; this is required for capturing any combination of times, venues, audio, images, gps locations . . . etc. Even the simplest version of the capture device will have memory. Therefore, there is an opportunity to provide another level of utility to the user and information to the advertisers and providers by downloading information to the device. In one of it's simplest embodiments, the user, while connected to the dedicated web site would have an opportunity to download electronic coupons from various retailers. These coupons would be “redeemed” by one of two means: docking their capture device at one of the retailer's physical locations or downloading the electronic coupon over the internet either as a part of, or separate from, their information based web site experience. (Additionally, scanned coupons can also be stored electronically and downloaded by either of the two means.)

### User Interaction, Influence and Nielsen Ratings

Inherent in the disclosure so far has been the important aspect of collecting information on users' interests and listening/watching/travel patterns once they have downloaded their placemark information or docked their capture device in a retail location. This information is not actively given by the user, but rather taken by the system. Therefore, as far as the user is concerned, information flows primarily from the internet to them once they have expressed interest in a particular topic or thing. However, the invention has the novel feature of allowing users to actively and specifically communicate information to venue providers and advertisers about their programming—a particular topic, song, advertisement or question posed with the system described.

Because it is expected that the venues will be actively promoting both the system and the use of capture devices, programmers, announcers and commercials will be able to actually prompt users to push a button on their capture device. They can do this by asking time dependent questions (“All of you who think a certain candidate should be the next president, press your button now!” All of you who think a different candidate should be the next president, press your button now!”) or button dependent questions (“Press your buttons once for candidate #1 and twice for candidate #2!”). Alternatively, “yes”, “no” or other buttons (“Give me a break”, “so-so show” . . . etc.) could be added to (or programmed into) capture devices to get an even more realistic dialogue between users and the venue providers. If a fund drive is being held on a TV or radio program, the announcer can prompt people to push their button at a specific time—that button push can be interpreted by the software differently from others so that the very first thing a user may see when he/she connects to the web is a screen thanking them for their patronage and asking for a VISA or Mastercard number.

Another provision would be to have standard button patterns established within or across venues for users to have a “voice” at all times: 1 quick push means “I want more info”, 2 quick pushes means “Great program” or “I love this song”, 1 long push (like leaning on a car horn) could mean “I don't like this song at all !” or “I totally disagree with what was just said!”.

Now venue providers and advertisers can get real feedback about how their users feel about their programming and users can have real influence about what shows up on their TV's and radios. In effect, the system provides a new “Nielsen” rating, except that it can encompass a much larger percentage of the population, cover many more venues and get specific feedback about program content and advertisement, not just determine whether someone has their TV tuned to a particular station. When more of the capture devices are web enabled, the user feedback to stations will be immediate and not require capture devices to be docked before user opinions can be determined.

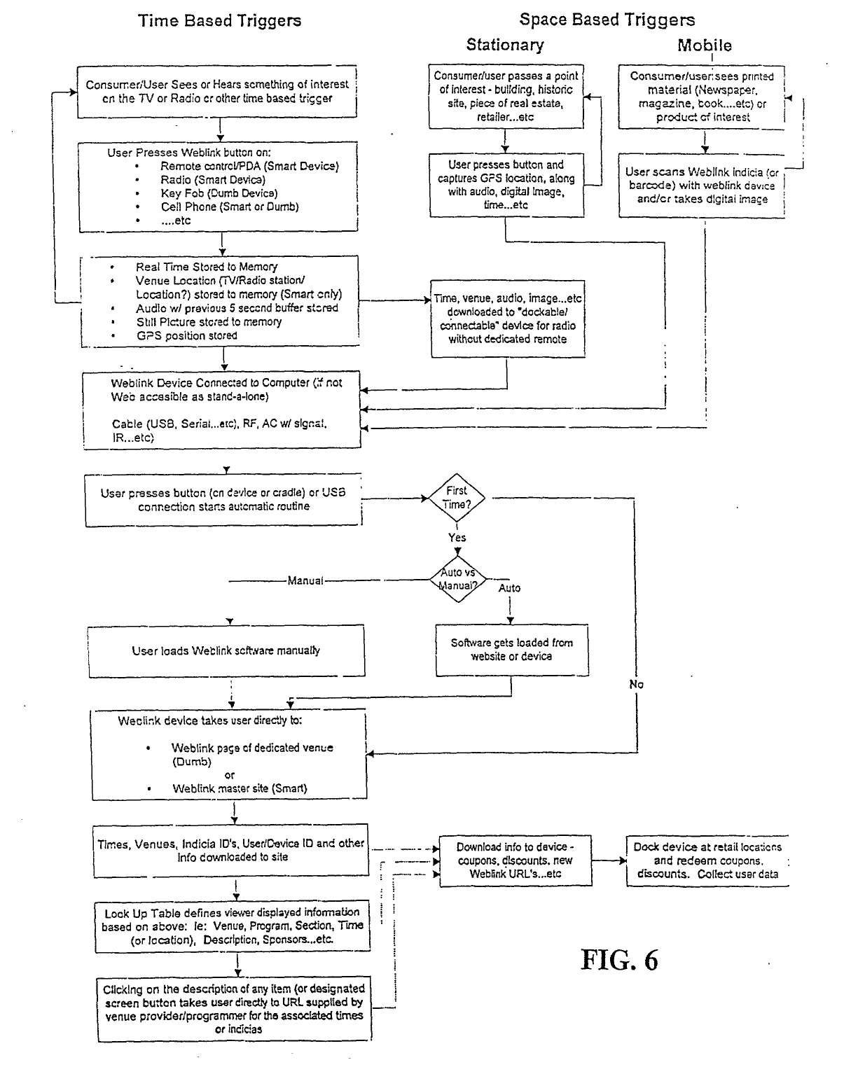

Finally, attention is directed to FIG. 6, which provides a more detailed consideration of the preferred process flow of the present invention. As shown therein, when the consumer sees or hears something of interest on the TV or radio, the user will press a button to capture or placemark the event in memory. Such button can be connected to a remote control/PDA, or in that regard, to a “smart device”, as well as a key fob (“non-smart device”) or even to a cell phone or other electronic devices. As a consequence, real time is stored to memory, and in the case of the “smart device” the device also records venue location, audio, images and/or gps coordinates as previously described. These characteristics can be used individually or in combination to refine the search.

Alternatively, and as illustrated on the right-hand-side of FIG. 6, a consumer may see printed material (newspaper), and scan the indicia therein with the capture device of the present invention. (The path for stationary space based triggers is not specifically shown, but is similar to that for mobile space based systems. The difference is that gps coordinates are downloaded instead of indicias.)

Once real time is stored to memory in the capture device of the present invention, time and venue may be optionally downloaded to a dockable connection device. Alternatively, the capture device herein may be directly connected to a computer via cable or other appropriate means, under those circumstances where it is not web accessible as a stand-alone product.

As can be seen from FIG. 6, at this point in time the user presses a button on the device (this can also be programmed to happen automatically). First time operation leads to an auto/manual decision point. If manual, the user would upload the system software, manually, and the capture device would take the user directly to a dedicated “placemark” venue site (“non-smart” device) or master “placemark” site in the case of the “smart” device. Times, venues, indicia ID's, audio, video, gps coordinates and user/device ID would be downloaded to such sites, and a look-up table would define viewer displayed information based on earlier mentioned considerations: venue, program, section, time (or location), description, sponsors, etc. Finally, clicking on the description of any item (or designated screen button) takes the user directly to the URL, supplied by the venue provider/programmer, for the associated times, indicias or coordinates. The master “placemark” site would be built in part from information supplied by each of the dedicated “placemark” sites.

As also illustrated in FIG. 6, in that situation wherein the device is being used for the first time, after placemarking by the user, the device may itself automatically provide that software is loaded from a website, or from the device itself, as opposed to having the user load software manually. The device would then proceed in the manner outlined above with regard to delivering the user to a page.

Finally, as noted above, in that situation where it is not the first time use of the device, after placemarking by the user, the device would take the user directly to either the page of a dedicated “placemark” venue (“non-smart”) or master “placemark” site (“smart”). That is, there would be no need for software loading, as previously described, and the remaining processing options would be identical.

Those skilled in the art will therefore appreciate that numerous alternatives to the invention as described herein are possible, without departing from the spirit and scope of the disclosure herein.

What is claimed is:

1. A system for capturing internet access information related to a selected television broadcast based upon the variables of time and channel associated with said broadcast, comprising:
(a) a capture unit comprising:
(i) a database for receiving and storing the time and channel of said selected television broadcast;
(ii) a selector which upon actuation thereof stores said time and channel of said selected television broadcast
(b) an interface for coupling said capture unit to said internet to access internet information wherein said interface extracts links from an internet web site which supplies said information related to said time and channel stored in said capture unit database.

2. The system of claim 1 wherein said capture unit contains a clock and said clock identifies a time associated with said channel stored in said capture unit database.

3. The system of claim 1 further including a global positioning system (gps) which identifies and stores gps coordinates and wherein said interface extracts links from an internet web site which supplies said internet access information related to said time, channel and gps coordinates stored in said capture unit database.

4. A system for capturing internet access information related to a selected television or video broadcast based upon a signal separate from the video or audio signal for said television or video broadcast signal comprising:
(a) a capture unit comprising:
(i) a database for receiving and storing said separate signal of said selected television or video broadcast;
(ii) a selector which upon actuation thereof stores a selected separate signal of said selected television or video broadcast
(b) an interface for coupling said capture unit to said internet to access internet information wherein said interface extracts links from an internet web site which supplies said information related to said separate signal stored in said capture unit database.

5. The system of claim 4 wherein said video broadcast comprises video produced from a device that plays prerecorded video.

6. The system of claim 4 wherein said capture unit contains a clock and said clock identifies a time associated with said selected separate signal.

7. The system of claim 4 further including a global positioning system (gps) which identifies an stores gps coordinates and wherein said interface extracts links from an internet web site which supplies said internet access information related to said selected separate signal and gps coordinates stored in said capture unit database.

8. A system for capturing internet access information related to a selected television or video broadcast based upon a selected signal within the video or audio signal for said television or video broadcast signal comprising:
(a) a capture unit comprising:
(i) a database for receiving and storing said selected signal within said selected television or video broadcast;
(ii) a selector which upon actuation thereof stores said selected signal within said selected television or video broadcast
(b) an interface for coupling said capture unit to said internet to access internet information wherein said interface extracts links from an internet web site which supplies said information related to said selected signal stored in said capture unit database.

9. The system of claim 8 wherein said video broadcast comprises video produced from a device that plays prerecorded video.

10. The system of claim 8 wherein said capture unit contains a clock and said clock identifies a time associated with said signal.

11. The system of claim 8 further including a global positioning system (gps) which identifies an stores gps coordinates and wherein said interface extracts links from an internet web site which supplies said internet access information related to said selected signal and gps coordinates stored in said capture unit database.

12. A system for capturing internet access information related to a selected radio or audio broadcast based upon the variables of time and channel associated with said broadcast, comprising:
(a) a capture unit comprising:
(i) a database for receiving and storing the time and channel of said selected radio or audio broadcast;
(ii) a selector which upon actuation thereof stores said time and channel of said selected radio or audio broadcast
(b) an interface for coupling said capture unit to said internet to access internet information wherein said interface extracts links from an internet web site which supplies said information related to said time and channel stored in said capture unit database.

13. The system of claim 12 wherein said capture unit contains a clock and said clock identifies a time associated with said channel stored in said capture unit database.

14. The system of claim 12 further including a global positioning system (gps) which identifies and stores gps coordinates and wherein said interface extracts links from an internet web site which supplies said internet access information related to said time, channel and gps coordinates stored in said capture unit database.

15. A system for capturing internet access information related to a selected radio or audio broadcast based upon a signal separate from the audio signal for said radio or audio broadcast comprising:
(a) a capture unit comprising:
(i) a database for receiving and storing said separate signal of said selected radio or audio broadcast;
(ii) a selector which upon actuation thereof stores said selected separate signal of said selected radio or audio broadcast
(b) an interface for coupling said capture unit to said internet to access internet information wherein said interface extracts links from an internet web site which supplies said information related to said separate signal stored in said capture unit database.

16. The system of claim 15 wherein said audio broadcast comprises audio produced from a device that plays prerecorded audio.

17. The system of claim 15 wherein said capture unit contains a clock and said clock identifies a time associated with said selected separate signal.

18. The system of claim 15 further including a global positioning system (gps) which identifies and stores gps coordinates and wherein said interface extracts links from an internet web site which supplies said internet access information related to said selected separate signal and gps coordinates stored in said capture unit database.

19. A system for capturing internet access information related to a selected radio or audio broadcast based upon a selected signal within the audio signal for said radio or audio broadcast comprising:
(a) a capture unit comprising:
(i) a database for receiving and storing said selected signal of said selected radio or audio broadcast;
(ii) a selector which upon actuation thereof stores said selected signal of said selected radio or audio broadcast
(b) an interface for coupling said capture unit to said internet to access internet information wherein said interface extracts links from an internet web site which supplies said information related to said selected signal stored in said capture unit database.

20. The system of claim 19 wherein said audio broadcast comprises audio produced from a device that plays prerecorded audio.

21. The system of claim 19 wherein said capture unit contains a clock and said clock identifies a time associated with said selected signal.

22. The system of claim 19 further including a global positioning system (gps) which identifies and stores gps coordinates and wherein said interface extracts links from an internet web site which supplies said internet access information related to said selected signal and gps coordinates stored in said capture unit database.

23. A system for capturing internet access information related to printed media based upon an icon associated with said printed material, comprising:
(a) a capture unit comprising:
(i) a database for receiving and storing said icon associated with said selected printed media;
(ii) a selector which upon actuation thereof stores said icon of said selected printed media;
(b) an interface for coupling said capture unit to said internet to access internet information wherein said interface extracts links from an internet web site which supplies said information related to said icon stored in said capture unit database.

24. The system of claim 23 wherein said capture unit comprises a digital imaging device or optical character recognition (OCR) device.

25. The system of claim 23 wherein said icon is a bar-code.

26. The system of claim 23 wherein said icon provides a serial number which is associated with said internet web site.

27. The system of claim 23 wherein said icon is a logo or trademark.

28. A system for capturing internet access information related to a physical item based upon the an icon associated with said item, comprising:
(a) a capture unit comprising:
(i) a database for receiving and storing said icon associated with said physical item;
(ii) a selector which upon actuation thereof stores said icon associated with said physical item;
(b) an interface for coupling said capture unit to said internet to access internet information wherein said interface extracts links from an internet web site which supplies said information related to said physical item stored in said capture unit database.

29. The system of claim 28 wherein said capture unit comprises a digital imaging device or optical character recognition (OCR) device.

30. The system of claim 28 wherein said icon is a bar code.

31. The system of claim 28 wherein said icon provides a serial number which is associated with said internet web site.

32. The system of claim 28 wherein said icon is a logo or trademark.

33. A system for capturing internet access information related to the visual aspects of a physical item comprising:
(a) a capture unit comprising:
(i) a database for receiving and storing said visual aspects associated with said physical item;
(ii) a selector which upon actuation thereof stores said visual aspects associated with said physical item;
(b) an interface for coupling said capture unit to said internet to access internet information wherein said interface extracts links from an internet web site based upon said visual aspects of said physical item and which supplies said information related to said visual aspects of said physical item stored in said capture unit database.

34. The system of claim 33 wherein said capture unit comprises a digital imaging device or optical character recognition (OCR) device.

35. The system of claim 33 wherein said visual aspect is a bar-code.

36. The system of claim 33 wherein said visual aspect provides a serial number which is associated with said internet web site.

37. The system of claim 33 wherein said visual aspects comprise a logo or trademark.

38. A system for capturing internet access information related to the audio aspects of an item comprising:
(a) a capture unit comprising:
(i) a database for receiving and storing said audio aspects associated with said item;
(ii) a selector which upon actuation thereof stores said audio aspects associated with said item;
(b) an interface for coupling said capture unit to said internet to access internet information wherein said interface extracts links from an internet web site based upon said audio aspects of said item and which supplies said information related to said audio aspects of said item stored in said capture unit database.

39. The system of claim 38 wherein said capture device includes an audio recirculating buffer.

40. The system of claim 38 wherein said audio aspects comprise audio produced from a device which plays prerecorded audio.

41. The system of claim 38 wherein said audio aspects include speech.

42. A system for capturing internet access information related to geographical position comprising:
(a) a capture unit comprising:
(i) a database for receiving and storing said geographical position;
(ii) a selector which upon actuation thereof stores said geographical position;
(b) an interface for coupling said capture unit to said internet to access internet information wherein said interface extracts links from an internet web site based upon said geographical position and which supplies said information related to geographical position stored in said capture unit database.

43. The system of claim 41 wherein said capture unit contains a global positioning system (gps) which detects said geographical position.

44. The system of claim 42 wherein said capture unit further captures a direction of movement.

45. The system of claim 42 wherein said capture unit detects an area in which the capture unit may be pointed.

46. A system for capturing internet access information related to at least two or more of the following variables: (1) visual aspects; (2) audio aspects; (3) geographical position or movement; (4) time, comprising:
(a) a capture unit comprising:
(i) a database for receiving and storing at least two or more of said variables;
(ii) a selector which upon actuation thereof stores at least two or more of said variables;
(b) an interface for coupling said capture unit to said internet to access internet information wherein said interface extracts links from an internet web site which supplies said information related to two or more of said variables stored in said capture unit database.

47. A method for capturing internet access information related to a selected television or video broadcast signal based upon the variables of time and channel associated with said broadcast, comprising:
(a) receiving a broadcast signal at a selected time on a selected channel;
(b) storing said time and channel associated with said broadcast signal;
(c) initiating internet access and extracting internet information associated with said stored time and channel associated with said broadcast signal.

48. A method for capturing internet access information related to a selected television or video broadcast signal based upon a signal separate from the video or audio signal for said television broadcast comprising:
(a) receiving said separate signal at a selected time on a selected channel;
(b) storing said separate signal and channel associated with said separate signal;
(c) initiating internet access and extracting internet information associated with said separate signal and channel of said broadcast signal.

49. A method for capturing internet access information related to a selected television channel broadcast signal based upon a signal within the video or audio signal for said television broadcast comprising:
(a) receiving said within signal at a selected time on a selected channel;
(b) storing said within signal and channel associated with said within signal;
(c) initiating internet access and extracting internet information associated with said within signal and channel of said broadcast signal.

50. A method for capturing internet access information related to a selected radio or audio broadcast signal based upon the variables of time and channel associated with said broadcast signal, comprising:
(a) receiving a broadcast signal at a selected time on a selected channel of said radio or audio broadcast;
(b) storing said time and channel associated with said radio or audio broadcast signal in a capture device; and
(c) initiating internet access and extracting internet information associated with said stored time and channel associated with said radio or audio broadcast signal.

51. A method for capturing internet access information related to a selected radio or audio channel broadcast signal based upon a signal separate from the audio signal for said radio or audio broadcast comprising:
(a) receiving said separate signal at a selected time on a selected channel;
(b) storing said separate signal and channel associated with said separate signal;
(c) initiating internet access and extracting internet information associated with said separate signal and channel of said radio or audio broadcast signal.

52. A method for capturing internet access information related to a selected radio or audio channel broadcast signal based upon a signal within the audio broadcast signal for said radio or audio broadcast comprising:
(a) receiving said within signal at a selected time on a selected channel;
(b) storing said within signal and channel associated with said within signal;
(c) initiating internet access and extracting internet information associated with said within signal and channel of said radio or audio broadcast signal.

53. A method for capturing internet access information related to printed media based upon an icon associated with said printed media, comprising:
(a) identifying an icon associated with said printed media;
(b) storing said icon associated with said printed media in a capture device;
(c) initiating internet access and extracting internet information associated with said stored icon associated with said printed media.

54. The method of claim 53 wherein said step of identifying said icon comprises identification via a digital imaging device or optical character recognition(OCR) device.

55. A method for capturing internet access information related to a physical item based upon an icon associated with said item, comprising:
(a) identifying an icon associated with said item;
(b) storing said icon associated with said item in a capture device;
(c) initiating internet access and extracting internet information associated with said stored icon associated with said item.

56. The method of claim 55 wherein said step of identifying said icon comprises identification with a digital imaging device.

57. A method for capturing internet access information related to visual aspects associated with a physical item, comprising:
(a) identifying said visual aspects associated with said physical item;
(b) storing said visual aspects associated with said physical item in a capture device;
(c) initiating internet access and extracting internet information associated with said stored visual aspects associated with said physical item.

58. The method of claim 57 wherein said identification of said visual aspects associated with said physical item comprises a portion of the visual aspects of said physical item.

59. The method of claim 58 further including identifying and storing a geographical position of said physical item via the use of a global positioning system (gps) and extracting internet information associated with said stored visual aspects and geographical position associated with said physical item.

60. A method for capturing internet access information related to audio aspects of an item, comprising:
(a) identifying audio aspects associated with said item;
(b) storing said audio aspects associated with said item in a capture device;
(c) initiating internet access and extracting internet information associated with said stored audio aspects associated with said item.

61. A method for capturing information related to a geographical position comprising:
(a) identifying said geographical position;
(b) storing said geographical position in a capture device;
(c) accessing a database and extracting information from said database associated with said geographical position.

62. The method of claim 61 wherein said information relates to information about parties, organizations, municipalities and/or businesses that may be identified with said geographical position.

63. The method of claim 61 wherein said database is the internet.

64. The method of claim 63, further comprises collecting and storing information associated with said geographical position and including such collected information in said internet information associated with said geographical position.

65. The method of claim 63 wherein said stored information includes web sites associated with said geographical position.

66. The method of claim 64 wherein said stored information includes information about parties, organizations, municipalities and/or businesses that may be identified with said geographical position.
